(19) United States
(12) Patent Application Publication
(10) Pub. No.: US 2026/0148552 A1
(43) Pub. Date: May 28, 2026

(54) REAL-TIME AUTOMATED DOCUMENT SCANNING

(71) Applicant: Adobe Inc., San Jose, CA (US)

(72) Inventors: Curtis WIGINGTON, Annandale, VA (US); Swapnil BHOITE, Fremont, CA (US); Anshul MALIK, San Jose, CA (US)

(73) Assignee: Adobe Inc., San Jose, CA (US)

(21) Appl. No.: 18/959,356

(22) Filed: Nov. 25, 2024

(51) Int. Cl. G06V 20/40; G06V 30/40

(52) U.S. Cl. CPC G06V 20/44; G06V 30/40

(57) ABSTRACT

Embodiments are disclosed for automated bulk document capture. The method may include receiving an input video comprising a plurality of frames. The input video depicts a plurality of document pages to be captured. A first machine learning model is used to determine a page turn event has been depicted in the input video based at least on a first frame of the input video. A second machine learning model is used to determine that a first frame of the input video is ready for capture. An image of a document page depicted in the first frame is then captured.

### BACKGROUND

Document scanning enables various physical documents to be captured and stored electronically. Typically, this is performed manually by a user with a scanner to capture each document individually or, in some instances, using a scanner with a feeding device multiple documents can be scanned sequentially. The ubiquity of mobile devices, such as smartphones and tablets, means that most users are now carrying a camera at all times. This enables mobile devices to be used for document capture. While the capture device may have changed, document scanning via mobile devices remains manual and error prone for end users.

### SUMMARY

Introduced here are techniques/technologies that enable real-time automated bulk document capture. Embodiments provide a capture pipeline that receives and analyzes a video frame from a video stream. The analysis determines whether a new page is depicted in the video stream. This determination may be made with a fast, lightweight model, which allows for processing to keep up with the framerate of the video stream. When a new page is detected, additional machine learning models are used to determine that the page is ready to be captured. This can mean, for example, that there is no obstruction over the document, it is fully in frame, it is not in motion, etc. When it is ready to capture, a request is made to trigger a capture.

In some embodiments, if a machine learning error or other processing delay leads to a frame still being processed as additional frames are received, the additional frames can be added to a smart queue. The smart queue allows for a number of frames to be stored intelligently, to minimize the distance between stored frames. This effectively spreads out the frames that are stored in the smart queue across the processing delay. This reduces the chance that all of the frames associated with a page turn event are dropped.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of automated bulk document capture in accordance with one or more embodiments;

FIG. 2 shows examples of frame processing with different queues, in accordance with an embodiment;

FIG. 3 shows examples of frame processing by a smart queue, in accordance with an embodiment;

FIG. 4 illustrates an example of determining page state and capture status, in accordance with an embodiment;

FIG. 5 illustrates an example of determining page state and capture status using a multi-frame input, in accordance with an embodiment;

FIG. 6 illustrates an example of mitigating ML errors, in accordance with an embodiment;

FIG. 7 illustrates a schematic diagram of document capture system in accordance with one or more embodiments;

FIG. 8 illustrates a flowchart of a series of acts in a method of automated bulk document capture in accordance with one or more embodiments; and

FIG. 9 illustrates a block diagram of an exemplary computing device in accordance with one or more embodiments.

### DETAILED DESCRIPTION

One or more embodiments of the present disclosure are directed to automatically capturing document pages from a video stream. Traditionally, bulk capture of documents has been a largely manual process, with pages captured one at a time and confirmed by the user Automated bulk document capture presents a number of challenges. For example, if bulk capture is slower than manual capture, or requires significant manual cleanup (e.g., recapture of missing pages, deletion of duplicates, etc.), then it will not be useful to the end user.

Common errors encountered during bulk document capture include skipping a page (e.g., page not captured) and double capturing (e.g., capture the same page twice). Additionally, these errors may include capturing a page with non-repairable issues (e.g., page is blurred, hand is covering content, etc.) or capturing a non-page (e.g., capture happens mid-page turn, a partial page is captured, capture occurs after the user sets the phone down or the user is no longer pointing at the document, etc.). Other issues that may occur during capture include the user experiencing excess delay where the user must wait a long time for a capture to happen, or where the user is forced to manually trigger a capture. Other errors can occur during post processing, such as boundary detection or automatic clean up failures.

To address these and other deficiencies in conventional systems, the document capture system of the present disclosure receives a video stream. The video stream includes a visual representation of document pages to be captured. This may include a video of a user flipping through pages to be captured, or a video panning over pages to be captured, or other depictions of multiple document pages to be captured. In some embodiments, the video stream may be a live video stream or a recording of a previous event.

To ensure the bulk capture is processed more quickly than manual captures while minimizing errors, a machine learning model can process the video stream in real-time and, in some embodiments, values from other sensors of the video capture device. Additionally, the ML model is trained to have a high enough accuracy that it minimizes errors that require manual correction. Also, a smart queue is provided to manage frames during a processing delay. The smart queue selectively stores frames to minimize the distance between stored frames. This way, the frames that are stored are spread out through the processing delay, reducing the chance that all frames associated with a page turn event are dropped. Further, a user interface is provided which indicates to the user that a capture was taken so they have confidence their document will not be missing pages. The document capture system can evaluate capture quality and inform the user of issues through the user interface. Also, the document capture system can be implemented using lightweight models, allowing for it to run a variety of device platforms.

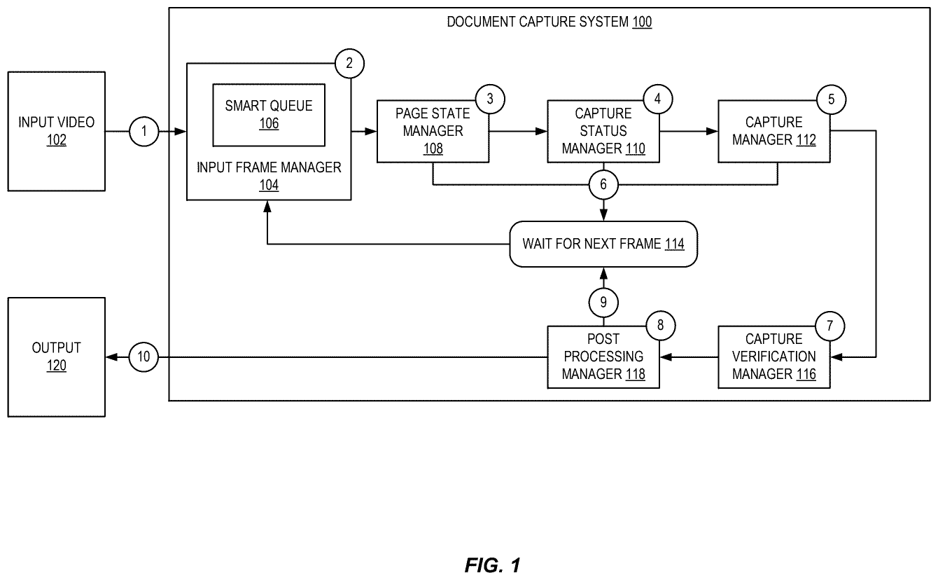

FIG. 1 illustrates a diagram of a process of automated bulk document capture in accordance with one or more embodiments. As shown in FIG. 1, document capture system 100 can process an input video 102 which depicts a number of document pages to be captured. The document capture system 100 can execute on a mobile device (such as a tablet, smartphone, etc.), laptop, desktop, or other computing device. In some embodiments, the input video 102 can be captured by a camera built into the device that is executing the document capture system 100 or communicatively coupled to the document capture system 100.

As shown in FIG. 1, the document capture system 100 receives the input video at numeral 1. The input video is received by an input frame manager 104. The input frame manager is responsible for passing frames to the rest of the bulk capture pipeline for processing, at numeral 2. Under ideal conditions, the input frame manager provides a video frame to page state manager 108. The page state manager 108 analyzes the video frame to determine if the page has changed at numeral 3. If it is determined that the current frame depicts a new page, then processing proceeds to capture status manager 110 which determines whether the page depicted in the frame is ready to be captured, at numeral 4. In this context, ready to capture means that the page is not obscured, partially out of frame, in motion, etc.

At numeral 5, after the capture status manager has determined the page is ready for capture, a capture manager 112 sends a request to the camera to capture the page. This may include sending a request to the device operating system to trigger a capture, sending a request directly to an attached camera to trigger the capture, etc. Typically, the input video is a lower resolution video. This is adequate for frame analysis, but a higher resolution image is required for document capture. By triggering the camera based on the frame analysis, the higher resolution can be captured only when the document is ready for capture. At any point the page state manager, capture status manager, and capture manager can indicate that their processing is complete, and they are waiting for the next frame, as shown at numeral 6.

In some embodiments, after a capture has been triggered, the resulting image can be verified by capture verification manager 116, as shown at numeral 7. This can include confirming that the image was successfully captured and that there are no artifacts or other visual issues with the captured image. At numeral 8, a post-processing manager 118 can perform any post-processing, such as motion deblur, color normalization, etc. In some embodiments, the post-processing manager 118 can indicate it has completed processing the captured image and is waiting for a next frame, as shown at numeral 9. In some embodiments, frame processing from steps 2-6 and steps 7-9 can occur concurrently (e.g., with steps 2-6 processing frame X+1, while steps 7-9 process frame X. Once all pages have been captured, the resulting batch of captures can be output as shown at numeral 10. This can include storing the captures to a specified location as a series of images, as a single file that includes a plurality of images, etc. In some embodiments, the output of the document capture system 100 may be received by another system, such as to perform optical character recognition or other processing of the content of the captured pages.

As noted above, under ideal processing conditions, the document capture system 100 may process each frame of the input video 102 until the entire video has been processed. However, this pipeline can experience a number of errors. As shown in FIG. 1, the input frame manager 104 can include a smart queue 106. The smart queue 106 stores a selection of non-consecutive frames that may otherwise be dropped, to be later processed by downstream components of the document capture system.

For example, if one frame takes too long to process, then the next frame may be dropped. Similarly, machine learning errors may lead to a number of mistakes. For example, if an ML model fails to detect that a page changed, then the processing may deadlock, or a page may be missed. Likewise, if the ML model detects a page change that did not occur then a duplicate capture may be made. Other problems may include triggering a capture on a bad frame, or rejecting a good capture, due to mistakes by the ML model. Errors may also be introduced in between processing stages, for example after a capture has been triggered, but before the capture is made, the user may move causing a blur, a partial obstruction, etc.

Video frames are provided by the device at a certain frame rate. This gives the steps represented by numerals 3-5 a certain amount of time to process a frame and release it before the next frame is ready to be processed. If the first frame is not processed in time, then the next frame and any subsequent frames may be dropped until the first frame is finished processing. Alternatively, camera libraries may allow for a queue of frames. This allows for frames to be queued for processing, so if one frame takes too long to process, the document capture system 100 can catch up using frames stored in the queue. This works if subsequent frames are processed faster, but if frames generally take too long to process, the queue will become full. If the queue reaches maximum capacity, the oldest frames in the queue or the new frames in the queue may be dropped, depending on implementation. Once frames are dropped, it becomes easy for important events, such as page turns, to be missed, leading to errors that require manual correction.

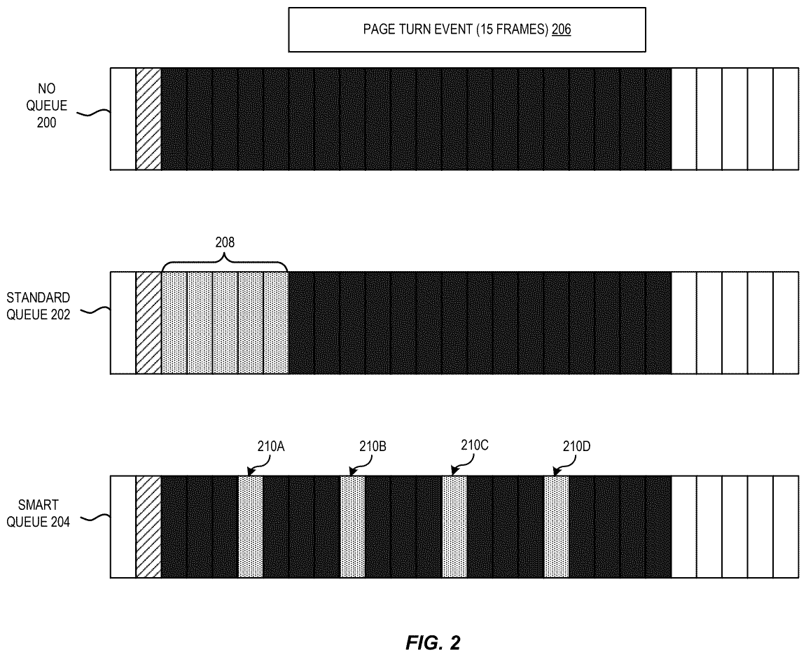

Embodiments address these issues using smart queue 106. Consider the following example shown in the FIG. 2. FIG. 2 shows examples of frame processing with different queues, in accordance with an embodiment. As shown in FIG. 2, each frame of an input video is depicted as a rectangle going from left to right on the x-axis. In the example of no queue 200 being used, the white boxes are frames that finished processing before the next frame (e.g., the first and last five frames). The hashed frame is a frame that took a long time to process (e.g., the second frame). The black frames are dropped frames. Where no queue 200 is used, the slow processing of one frame leads to about twenty dropped frames.

This loss from frames can be mitigated by adding a standard queue 202. In the example of FIG. 2, the standard queue allows for five frames 208 to be added to the queue before it is full, leading to the remaining black frames to be dropped. As shown, even where a queue is used, it is possible to entirely miss all the frames associated with a page turn event 206 if a frame takes too long to process. However, a Smart Queue allows for the queue to be filled intelligently with frames to minimize the distance between any two frames (e.g., as measured in frame count, time, etc.). This helps ensure that a page turn is not missed. For example, instead of the smart queue 204 filling up and dropping subsequent frames (as in the case of the standard queue 202), embodiments drop the frame that produces the minimal time delta between its two neighboring frames. Formally, the frame is selected by finding the optimal value of “i”.

$$arg max ( {Frame}_{i - 1} - {Frame}_{i + 1} )$$

In this example, this results in every fourth frame 210A-D being added to the smart queue.

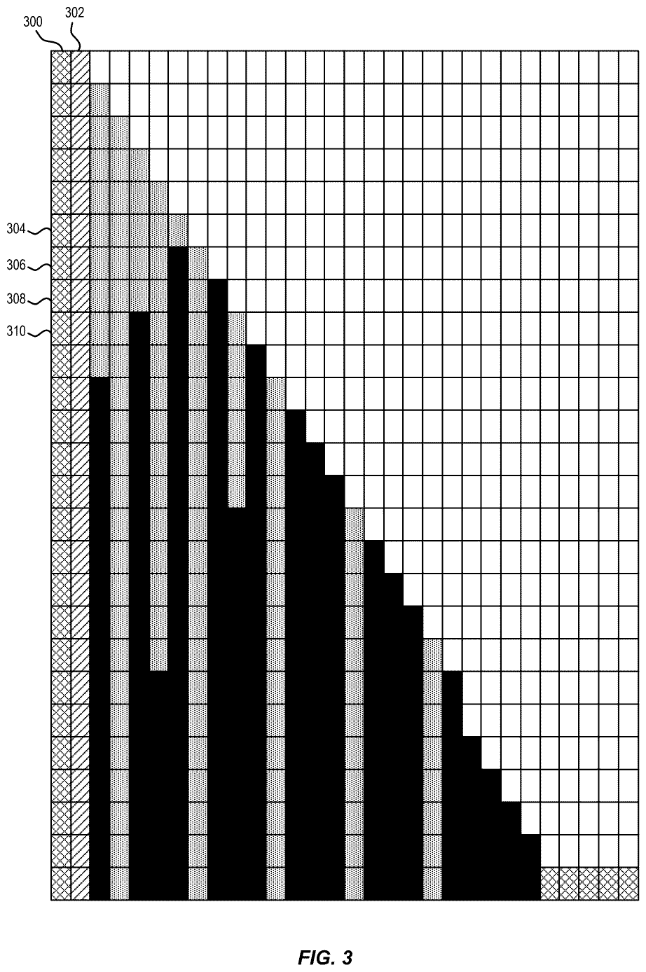

FIG. 3 shows examples of frame processing by a smart queue, in accordance with an embodiment. The example of FIG. 3 depicts how frames are added and dropped using the smart queue described above. In this example, the white squares represent frames that have not yet been received. From top to bottom, the frames currently in the queue are shown. When there is a tie, the right most frame is dropped. As shown in this example, the frames are not as perfectly distributed as shown in the previous figure. However, they are more evenly distributed.

For example, as shown in FIG. 3, the crosshatched squares in column 300 represent a frame that is received and processed normally. The next frame experiences a processing delay, represented by hatched squares in column 302. This leads to the next several frames being enqueued. However, unlike prior queues, the queue does not merely fill up and then drop frames. Instead, as shown in FIG. 3, the next five frames are enqueued as shown in row 304. In row 306, when another new frame is received, the most recently enqueued frame is dropped and the new frame is added. The next frame is then received and dropped, as shown in row 308. When another new frame is received in row 310, that frame is added to the queue and an earlier queued frame is dropped. As shown in FIG. 3, as processing continues the queued frames are gradually spread out among the dropped frames. This increases the likelihood that a page turn event will be captured by at least one frame, making it less likely that a page turn will be missed by the document capture system.

The machine learning model is trained with dropped frames. It can properly interpret just a few frames where a page turn is happening. However, it will not work if all the page turn frames are missing. By distributing the dropped frames, the chance of dropping all of the frames associated with a page change is minimized.

Ideally, the queue should be empty or nearly empty. This would indicate that the model is keeping pace with the stream of frames as they are received. If the smart queue always has elements in it, then this indicates that the user experience is lagging N frames behind real-time. The default frames per second (FPS) to target is 30 FPS. However, if the device in use is consistently not keeping up, then the target FPS is reduced. In some embodiments, the model is trained at various FPS values.

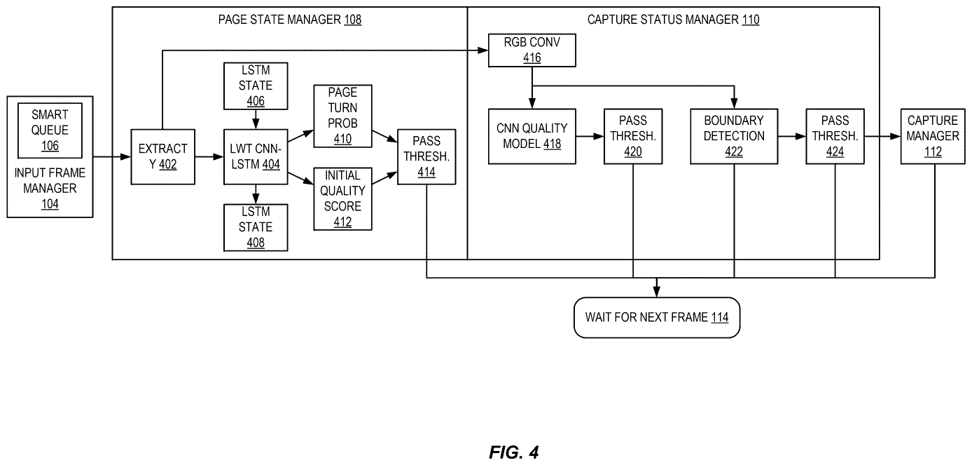

FIG. 4 illustrates an example of determining page state and capture status, in accordance with an embodiment. As shown in FIG. 4, the page state manager 108 can receive a frame from the smart queue 106 and process the frame to predict whether the page has been turned. In some embodiments, the frames may be received in the YUV color scale. In such instances, as a first step, the Y channel, representing luma, can be extracted at 402. This results in a grayscale image being processed by the Lightweight Convolutional Neural Network-Long Short-Term Memory (CNN-LSTM) model 404. Although a CNN-LSTM model is referenced herein, in various embodiments any recurrent model may be used.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The CNN-LSTM model 404 predicts if a page turn has occurred 410 and an initial quality score prediction 412 representing the page quality. This model is very lightweight (e.g., less than 1 MB deployed on device). This allows for the model to process every non-dropped frame at, ideally, 30 FPS on many devices having varying levels of resources. However, being lightweight comes at the cost of model accuracy. Accordingly, the threshold for initial quality score prediction is set to a low value.

In some embodiments, the CNN-LSTM model 404 is trained with a 5-frame delay to the page change prediction. This means rather than the model being trained to predict if a page change occurred in that very frame, learns to predict if the page change occurred five frames ago. The intuition being that in the exact moment it can be ambiguous if the page is changing, or some other movement is occurring. By delaying the output, the model gets the additional context of the next five frames, which was determined to lead to better accuracy without introducing so much delay as to impact the user experience. It is also worth noting that, the 5-frame delay does not mean the model holds on to the last 5 frames, rather it is implicitly handled in the recurrent memory of the LSTM (e.g., LSTM state 406, 408).

While this model is quite fast, it may not reach high enough FPS on slower devices. Accordingly, grayscale inputs to further improve performance. This helps in two ways: (1) by default Android provides video frames in the YUV colorscale (Y being grayscale) and thus avoids RGB conversion overhead and (2) a small amount computation is saved on the first convolution layer by reducing the number of input channels.

The page turn probability 410 and initial quality score 412 are compared to threshold values at 414. If the frame passes the threshold checks, then it can be passed to the capture status manager 110. The capture status manager 110 can perform more expensive quality checks, which require more processing resources and more time to process the frame. For example, in some embodiments, if the frame is in a non-RGB color scale, the first step performed by the capture status manager 110 can be to convert the frame to RGB at 416. The RGB frame can then be provided to a CNN quality model 418 and a boundary detection model 422.

The CNN Quality Model 418 only runs if the Lightweight CNN-LSTM predicts the document is ready for capture (e.g., based on page turn probability and initial quality score passing their associated thresholds). As discussed, if needed at this point the YUV image is converted to RGB at 416. The CNN quality model 418 produces higher accuracy results with RGB images and the overhead is less when compared to the run time of the CNN Quality Model. In some embodiments, the CNN quality model 418 is a MobileNetV2 model, but other mobile CNN models could be used. This model also predicts a value between 0-1, but because the model is more accurate, the pass threshold is set to a higher value, such as 0.8.

If the CNN Quality Model 418 predicts a sufficiently high quality/capture score, then the boundary detection model 422 performs its verification. The boundary detection model makes sure that clear boundaries of the document page can be identified in the frame before capture. The CNN quality model 418 and boundary detection model 422 run slower than the target FPS. This is where the smart queue is used to avoid dropping frames that coincide with a page turn event. In practice, the capture status manager 110 executes infrequently enough that usually the smart queue does not fill up at all or only drops a small number of frames.

During, and around, camera capture time is when there are the most demands for processing resources on the device. The CNN quality model and boundary detection models run while the page state manager is still running (e.g., on the next frame), the capture process is happening, and postprocessing is occurring on the document page. With all these processes happening in the same window of time, there is an increased chance of dropped frames. Additionally, because a capture just happened, it is the most likely moment for a page turn. The smart queue reduces the chance that this will result in a complete loss of frames associated with a page turn event.

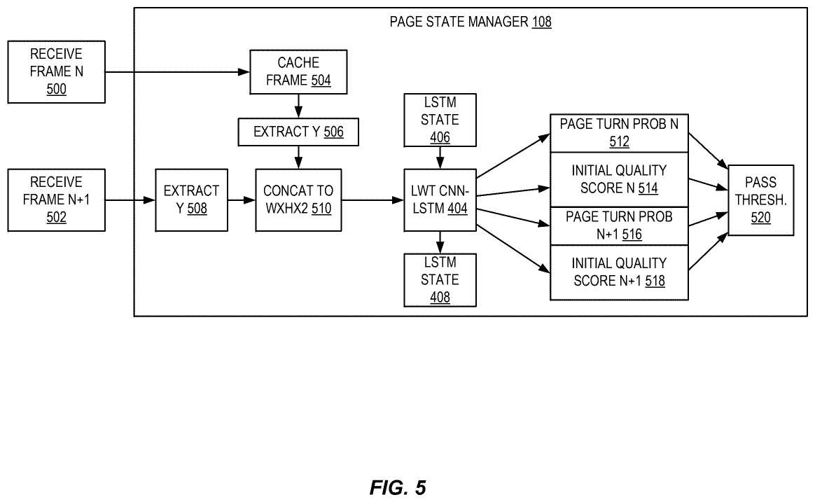

FIG. 5 illustrates an example of determining page state and capture status using a multi-frame input, in accordance with an embodiment. In the example of FIG. 5, multiple frames (e.g., frame N 500 and frame N+1 502) can be received by the page state manager 108. Instead of running each frame the moment it is received, one or more frames can be cached 504 and processed in a batch. However, rather than the traditional “batch” used in deep learning, embodiments stack multiple frames into the channels of the image. For example, as shown in FIG. 5, the Y channel of frames N and N+1 can be extracted at 506 and 508. These are then combined into multiple channels of a single image at concatenation block 510.

The lightweight CNN-LSTM model 404 then processes the multiple frames together. This results in the CNN LSTM model generating a separate output for each frame. For example, a page turn probability is generated for frame N and N+1 at 512 and 516 and an initial quality score is generated for frame N and N+1 at 514 and 518. Each of these can be compared to corresponding pass thresholds 520, as discussed above. Because the model is processing multiple frames together, some processing is necessarily shared. This could result in lower accuracy do to shared parameters or a lagging user experience as there is only an output from the model every N frames. In the example of FIG. 5, N=2, which was experimentally determined to be a good balance of accuracy and speed. With N=2, the computation cost is effectively reduced by half for the part of the process that runs the most frequently.

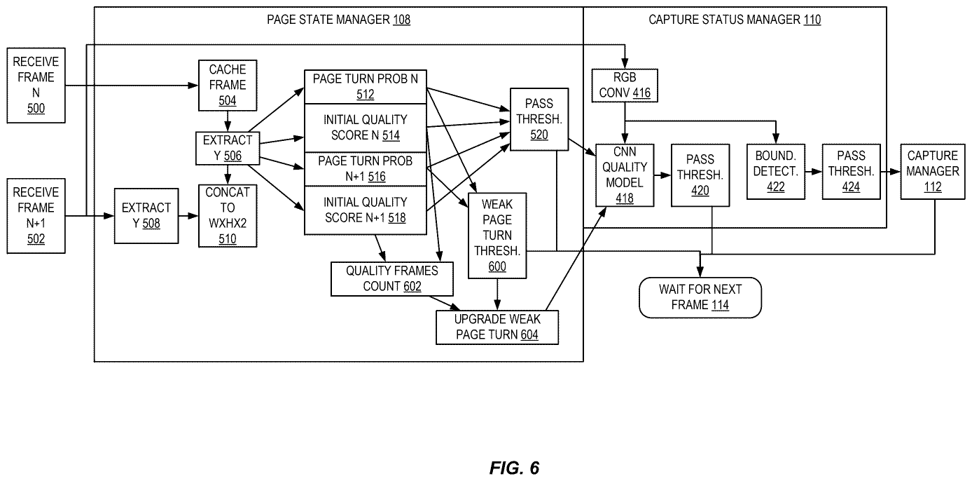

FIG. 6 illustrates an example of mitigating ML errors, in accordance with an embodiment. As noted above, ML errors can lead to a number of issues that result in a poor user experience. One of the worst kinds of errors that occurs is when the user is stuck waiting for a capture and the model is in a state where it will never trigger a capture. This is usually either due to a missed page turn, due to dropped frames, or a failure in the quality model.

Due to several factors, the page turn model may predict a page turn, but not with sufficient confidence to pass the threshold. This may be referred to as a weak page turn, and additional checks can be added to account for this outcome. For example, a weak page turn threshold 600 can be added to the page state manager 108. A weak page turn event happens when the model reaches the weak page turn threshold (which may be a lower threshold than the page turn threshold in pass thresholds 520). If a weak page turn has occurred, the page state manager 108 tracks how many times the model passes the initial quality threshold. For example, the page state manager 108 can include a quality frames counter 602. This can be implemented as a counter which receives inputs of initial quality scores for each frame and increments each time the quality score is above a threshold. If a quality score is below the threshold, then the quality frames counter 602 is reset to zero. If the model passes the quality threshold for M frames in a row, then at 604, the “weak page change” is upgraded to a regular “page change”.

In some embodiments, additional device sensor data (e.g., accelerator and magnetic field sensor readings) may be used to process frames. For example, the duration of time the device is considered stable, based on sensor readings is recorded. This may be determined using the inertial measurement unit (IMU) on the device, which allows for the acceleration of the device to be measured in the x, y, and z planes and the rotational positions for pitch, roll, and azimuth. Thresholds are defined for both in-hand stability and surface stability. Embodiments keep track of how long the device measurements stay lower than each threshold. Different user experiences can be enabled depending on whether the user has set down the device or is stably holding the device in their hand.

For example, if the user holds the device stable for a certain amount of time, the user is likely waiting for a capture. If the user is continually holding the device in a stable position, there is a good chance the model has failed in some way and the user is waiting and expecting it to trigger a capture. In some embodiments, the capture threshold (e.g., the quality threshold and/or boundary threshold) for triggering a capture can be dynamically adjusted the longer the device is held in a stable position. For example, embodiments calculate an integral error proportional to time. This integral error continually lowers the threshold value for the model to trigger a capture. This prevents the user from indefinitely waiting for a capture to happen.

For example, suppose the standard acceptable threshold to trigger a capture is 0.8. After a duration of time (e.g., 2000 ms), it would reach the lowest acceptable threshold of 0.2. During these two seconds, assuming the user has maintained the phone in stable position, the threshold would have been linearly decreased during these two seconds. For instance, at 1 second, the threshold would be at 0.5. Every time the stability score exceeds its threshold, the capture threshold resets to 0.8. This approach helps solve the situations where the model fails to recognize a page as ready to capture, but the user is highly likely holding the camera steady, ready for capture.

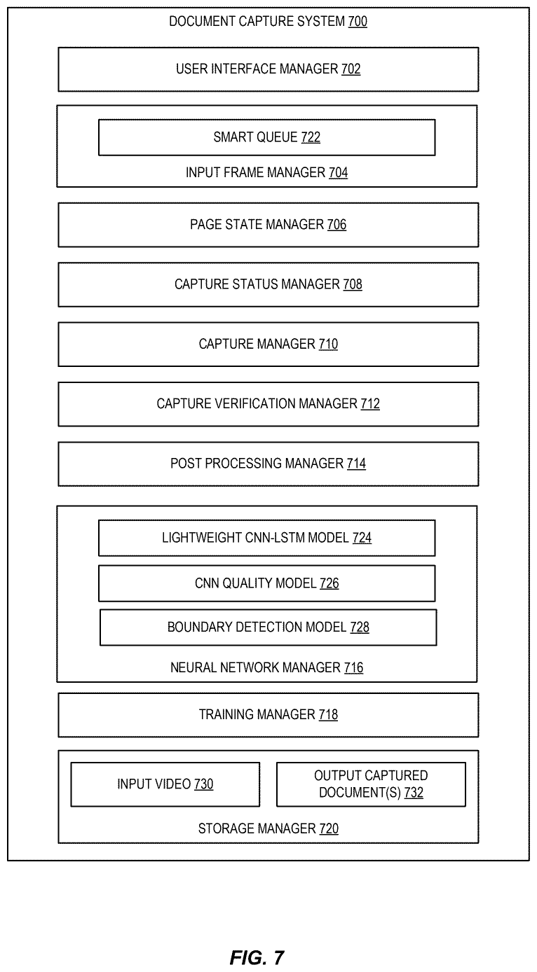

FIG. 7 illustrates a schematic diagram of document capture system (e.g., “document capture system” described above) in accordance with one or more embodiments. As shown, the document capture system 700 may include, but is not limited to, user interface manager 702, input frame manager 704, page state manager 706, capture status manager 708, capture manager 710, capture verification manager 712, post processing manager 714, neural network manager 716, training manager 718, and storage manager 720. The input frame manager 702 includes a smart queue 722. The neural network manager 716 includes a lightweight CNN-LSTM model 724, a CNN quality model 726, and a boundary detection model 728. The storage manager 720 includes input video 730 and output captured documents 732.

As illustrated in FIG. 7, the document capture system 700 includes a user interface manager 702. For example, the user interface manager 702 allows users to provide input video 730 to the document capture system 700. In some embodiments, the user interface manager 702 provides a user interface through which the user can upload, stream, or otherwise provide the input video 730 which represents the target documents to be captured, as discussed above. Alternatively, or additionally, the user interface may enable the user to download the video from a local or remote storage location (e.g., by providing an address (e.g., a URL or other endpoint) associated with a data source). In some embodiments, the user interface manager can enable a user to link an image capture device, such as a camera or other hardware to capture video data and provide it to the document capture system 700. Additionally, the user interface manager 702 allows users to request the document capture system 700 to begin capturing document pages represented in the video data.

As illustrated in FIG. 7, the document capture system 700 includes an input frame manager 704. The input frame manager 704 can receive the input video. For example, the input frame manager can receive the video one frame at a time at the frame rate, as the video data is captured by a connected image capture device (e.g., a camera, etc.). The input frame manager 704 is responsible for passing frames to the other components of the document capture system and for managing the smart queue. Unlike traditional queues which may reach capacity and then drop excess frames, the smart queue 722 can store frames from across the period of time during which frames are being dropped. In particular, the smart queue can selectively add and drop frames to store frames with a minimized distance between stored frames. This reduces the likelihood of a given event (e.g., a page turn event) being completely missed by any stored frames.

As illustrated in FIG. 7, the document capture system 700 also includes a page state manager 706. The page state manager 706 can process each frame using a lightweight CNN-LSTM model 724 which predicts whether a page turn event has occurred and predicts an initial quality score for the frame. As discussed, the use of a lightweight model enables processing to proceed quickly, to keep up with the framerate of the input video 730. The page turn prediction and initial quality score can be compared to threshold values to determine whether a page turn event has been detected. In some embodiments, this may be augmented to identify weak page turn events, as discussed above. Once a page turn event has been identified, processing can proceed to capture status manager 708.

As illustrated in FIG. 7, the document capture system 700 also includes a capture status manager 708. The capture status manager is responsible for determining whether the document page depicted in the frame is ready to be captured (e.g., is the quality sufficient for capture, is the entire page shown free of obstructions, etc.). As discussed, the capture status manager 110 can perform these steps using heavier machine learning models CNN quality model 726 and boundary detection model 728. Because the capture status manager processes many fewer frames than the page state manager 706, the added processing time by these models can be handled by the document capture system without introducing too much delay. However, if processing does take longer than expected, frames may be added to the smart queue for later processing, as discussed. The CNN quality model 726 produces a more reliable quality score for the frame and, if it exceeds the quality threshold, then the boundary detection model 728 can determine whether the entire boundary of the document page is depicted in the frame. If both conditions pass, then processing may proceed to the capture manager 710.

As illustrated in FIG. 7, the document capture system 700 also includes a capture manager 710. The capture manager sends a request to the camera to capture the page. This may include sending a request to the device operating system to trigger a capture, sending a request directly to an attached camera to trigger the capture, etc. By triggering the camera based on the frame analysis, a high-resolution capture of the document page is captured only when the document is ready for capture.

As illustrated in FIG. 7, the document capture system 700 also includes a capture verification manager 712. Because there is a time delay between the instruction for capture being sent and the actual capture by the camera, it is possible for motion blur, obstructions, or other changes to the composition of the frame to interfere with the quality or completeness of the capture. The capture verification manager can ensure that there are no artifacts or other visual issues with the captured image.

As illustrated in FIG. 7, the document capture system 700 also includes a post processing manager 714. The post-processing manager 714 can perform any post-processing, such as motion deblur, color normalization, etc. In some embodiments, the capture verification manager 712 and the post processing manager 714 can operate concurrently on different frames. For example, as discussed, the page state manager, capture status manager, and capture manager can indicate that their processing is complete, and they are waiting for the next frame. These managers may then move on to processing the next frame while the capture verification manager and post processing manager finish operating on the current frame.

As illustrated in FIG. 7, the document capture system 700 also includes a neural network manager 704. Neural network manager 716 may host a plurality of neural networks or other machine learning models, such as lightweight CNN-LSTM model 724, CNN quality model 726, and boundary detection model 728. The neural network manager 716 may include an execution environment, libraries, and/or any other data needed to execute the machine learning models. In some embodiments, the neural network manager 716 may be associated with dedicated software and/or hardware resources to execute the machine learning models. Although depicted in FIG. 7 as being hosted by a single neural network manager 716, in various embodiments the neural networks may be hosted in multiple neural network managers and/or as part of different components. For example, each model can be hosted by their own neural network manager, or other host environment, in which the respective neural networks execute, or the models may be spread across multiple neural network managers depending on, e.g., the resource requirements of each model, etc.

As illustrated in FIG. 7 the document capture system 700 also includes training manager 710. The training manager 710 can teach, guide, tune, and/or train one or more neural networks. In particular, the training manager 710 can train a neural network based on a plurality of training data. For example, the models may be trained to identify frame quality and page turn events, as discussed. Additionally, the models may be further optimized using loss functions, as discussed above, by backpropagating gradient descents. More specifically, the training manager 710 can access, identify, generate, create, and/or determine training input and utilize the training input to train and fine-tune a neural network.

As illustrated in FIG. 7, the document capture system 700 also includes the storage manager 720. The storage manager 720 maintains data for the document capture system 700. The storage manager 720 can maintain data of any type, size, or kind as necessary to perform the functions of the document capture system 700. The storage manager 720, as shown in FIG. 7, includes the input video 730. The input video 730 can include depictions of multiple document pages, as discussed in additional detail above. The document pages are captured in bulk, as discussed above and can be output as captured documents 732. This may include a plurality of separate files corresponding to different documents or a single document including pages corresponding to the captured document pages.

Each of the components 702-710 of the document capture system 700 and their corresponding elements (as shown in FIG. 7) may be in communication with one another using any suitable communication technologies. It will be recognized that although components 702-710 and their corresponding elements are shown to be separate in FIG. 7, any of components 702-710 and their corresponding elements may be combined into fewer components, such as into a single facility or module, divided into more components, or configured into different components as may serve a particular embodiment.

The components 702-710 and their corresponding elements can comprise software, hardware, or both. For example, the components 702-710 and their corresponding elements can comprise one or more instructions stored on a computer-readable storage medium and executable by processors of one or more computing devices. When executed by the one or more processors, the computer-executable instructions of the document capture system 700 can cause a client device and/or a server device to perform the methods described herein. Alternatively, the components 702-710 and their corresponding elements can comprise hardware, such as a special purpose processing device to perform a certain function or group of functions. Additionally, the components 702-710 and their corresponding elements can comprise a combination of computer-executable instructions and hardware.

Furthermore, the components 702-710 of the document capture system 700 may, for example, be implemented as one or more stand-alone applications, as one or more modules of an application, as one or more plug-ins, as one or more library functions or functions that may be called by other applications, and/or as a cloud-computing model. Thus, the components 702-710 of the document capture system 700 may be implemented as a stand-alone application, such as a desktop or mobile application. Furthermore, the components 702-710 of the document capture system 700 may be implemented as one or more web-based applications hosted on a remote server. Alternatively, or additionally, the components of the document capture system 700 may be implemented in a suite of mobile device applications or “apps.”

As shown, the document capture system 700 can be implemented as a single system. In other embodiments, the document capture system 700 can be implemented in whole, or in part, across multiple systems. For example, one or more functions of the document capture system 700 can be performed by one or more servers, and one or more functions of the document capture system 700 can be performed by one or more client devices. The one or more servers and/or one or more client devices may generate, store, receive, and transmit any type of data used by the document capture system 700, as described herein.

In one implementation, the one or more client devices can include or implement at least a portion of the document capture system 700. In other implementations, the one or more servers can include or implement at least a portion of the document capture system 700. For instance, the document capture system 700 can include an application running on the one or more servers or a portion of the document capture system 700 can be downloaded from the one or more servers. Additionally or alternatively, the document capture system 700 can include a web hosting application that allows the client device(s) to interact with content hosted at the one or more server(s).

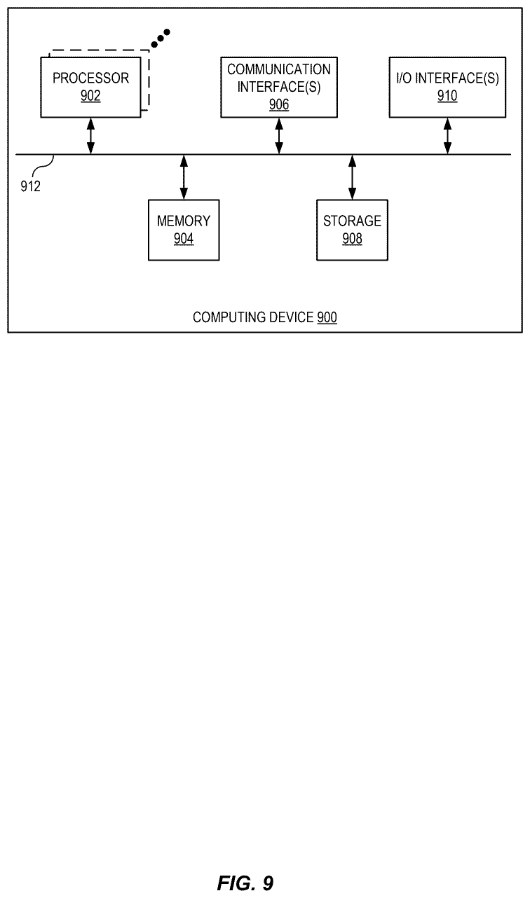

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 9. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 9.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 9.

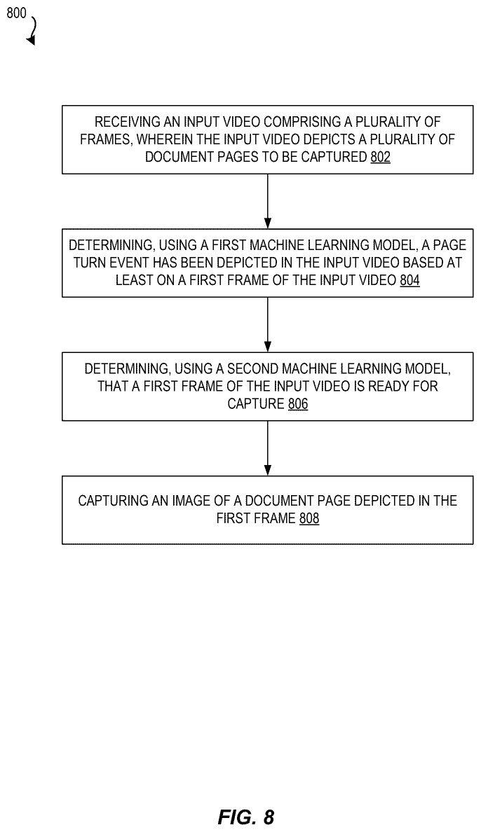

FIGS. 1-7, the corresponding text, and the examples, provide a number of different systems and devices that enable automated bulk document capture. In addition to the foregoing, embodiments can also be described in terms of flowcharts comprising acts and steps in a method for accomplishing a particular result. For example, FIG. 8 illustrates a flowchart of an exemplary method in accordance with one or more embodiments. The method described in relation to FIG. 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart 800 of a series of acts in a method of automated bulk document capture in accordance with one or more embodiments. In one or more embodiments, the method 800 is performed in a digital medium environment that includes the document capture system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of receiving an input video comprising a plurality of frames, wherein the input video depicts a plurality of document pages to be captured. As discussed, the input video can be streamed from a camera integrated with, or connected to, the device running the document capture system. The frames are processed sequentially as they are received in the video stream. This allows for the process to cascade from component to component as needed, improving the execution speed of the document capture system.

As illustrated in FIG. 8, the method 800 also includes an act 804 of determining, using a first machine learning model, a page turn event has been depicted in the input video based at least on a first frame of the input video. In some embodiments, the first machine learning model is a lightweight CNN-LSTM model which receives an input image and outputs an initial quality score prediction and a page turn event prediction. In some embodiments, determining, using a first machine learning model, a page turn event has been depicted in the input video based at least on a first frame of the input video further includes determining the initial quality score prediction and the page turn event prediction exceed threshold values, and sending at least the first frame of the input video to the second machine learning model for processing.

In some embodiments, determining, using a first machine learning model, a page turn event has been depicted in the input video based at least on a first frame of the input video further includes determining the page turn event prediction does not exceed a threshold value; determining a plurality of consecutive frames have associated initial quality score predictions that exceed the threshold value, and sending at least the first frame of the input video to the second machine learning model for processing. In some embodiments, the input image includes a plurality of frames of the input video, wherein each frame is included as a different channel of the input image.

As illustrated in FIG. 8, the method 800 also includes an act 806 of determining, using a second machine learning model, that a first frame of the input video is ready for capture. In some embodiments, determining, using a second machine learning model, that a first frame of the input video is ready for capture further includes comparing a quality score predicted by the second machine learning model to a capture threshold, dynamically adjusting the capture threshold based on device stability, and determining the quality score exceeds the dynamically adjusted capture threshold.

As illustrated in FIG. 8, the method 800 also includes an act 808 of capturing an image of a document page depicted in the first frame. In some embodiments, while the image of the document page depicted in the first frame is being captured, processing a next frame by the first machine learning model.

In some embodiments, the method further includes receiving a second frame of the input video while the first frame is being processed by the second machine learning model, and adding the second frame to a smart queue. In some embodiments, the smart queue selective stores a plurality of frames from the input video such that a distance between stored frames is minimized.

In some embodiments, the method further includes determining, using a first machine learning model, a page turn event has not been depicted in the input video, and waiting for a next frame of the input video.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that one or more computing devices such as the computing device 900 may implement the document capture system. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving an input video comprising a plurality of frames, wherein the input video depicts a plurality of document pages to be captured;
determining, using a first machine learning model, a page turn event has been depicted in the input video based at least on a first frame of the input video;
determining, using a second machine learning model, that a first frame of the input video is ready for capture; and
capturing an image of a document page depicted in the first frame.

2. The method of claim 1, wherein while the image of the document page depicted in the first frame is being captured, processing a next frame by the first machine learning model.

3. The method of claim 1, further comprising:
receiving a second frame of the input video while the first frame is being processed by the second machine learning model; and
adding the second frame to a smart queue.

4. The method of claim 3, wherein the smart queue selective stores a plurality of frames from the input video such that a distance between stored frames is minimized.

5. The method of claim 1, wherein the first machine learning model is a lightweight recurrent model which receives an input image and outputs an initial quality score prediction and a page turn event prediction.

6. The method of claim 5, wherein determining, using a first machine learning model, a page turn event has been depicted in the input video based at least on a first frame of the input video further comprises:
determining the initial quality score prediction and the page turn event prediction exceed threshold values; and
sending at least the first frame of the input video to the second machine learning model for processing.

7. The method of claim 5, wherein determining, using a first machine learning model, a page turn event has been depicted in the input video based at least on a first frame of the input video further comprises:
determining the page turn event prediction does not exceed a threshold value;
determining a plurality of consecutive frames have associated initial quality score predictions that exceed the threshold value; and
sending at least the first frame of the input video to the second machine learning model for processing.

8. The method of claim 5, wherein the input image includes a plurality of frames of the input video, wherein each frame is included as a different channel of the input image.

9. The method of claim 1 wherein determining, using a second machine learning model, that a first frame of the input video is ready for capture further comprises:
comparing a quality score predicted by the second machine learning model to a capture threshold;
dynamically adjusting the capture threshold based on device stability; and
determining the quality score exceeds the dynamically adjusted capture threshold.

10. The method of claim 1, further comprising:
determining, using a first machine learning model, a page turn event has not been depicted in the input video; and
waiting for a next frame of the input video.

11. A non-transitory computer-readable medium storing executable instructions, which when executed by a processing device, cause the processing device to perform operations comprising:
receiving an input video comprising a plurality of frames, wherein the input video depicts a plurality of document pages to be captured;
determining, using a first machine learning model, a page turn event has been depicted in the input video based at least on a first frame of the input video;
determining, using a second machine learning model, that a first frame of the input video is ready for capture; and
capturing an image of a document page depicted in the first frame.

12. The non-transitory computer-readable medium of claim 11, wherein while the image of the document page depicted in the first frame is being captured, processing a next frame by the first machine learning model.

13. The non-transitory computer-readable medium of claim 11, wherein the instructions further cause the processing device to perform operations comprising:
receiving a second frame of the input video while the first frame is being processed by the second machine learning model; and
adding the second frame to a smart queue, wherein the smart queue selective stores a plurality of frames from the input video such that a distance between stored frames is minimized.

14. The non-transitory computer-readable medium of claim 11, wherein the first machine learning model is a lightweight recurrent model which receives an input image and outputs an initial quality score prediction and a page turn event prediction.

15. The non-transitory computer-readable medium of claim 14, wherein the operation of determining, using a first machine learning model, a page turn event has been depicted in the input video based at least on a first frame of the input video further comprises:
determining the initial quality score prediction and the page turn event prediction exceed threshold values; and
sending at least the first frame of the input video to the second machine learning model for processing.

16. The non-transitory computer-readable medium of claim 14, wherein the operation of determining, using a first machine learning model, a page turn event has been depicted in the input video based at least on a first frame of the input video further comprises:
determining the page turn event prediction does not exceed a threshold value;
determining a plurality of consecutive frames have associated initial quality score predictions that exceed the threshold value; and
sending at least the first frame of the input video to the second machine learning model for processing.

17. The non-transitory computer-readable medium of claim 14, wherein the input image includes a plurality of frames of the input video, wherein each frame is included as a different channel of the input image.

18. The non-transitory computer-readable medium of claim 11 wherein the operation of determining, using a second machine learning model, that a first frame of the input video is ready for capture further comprises:
comparing a quality score predicted by the second machine learning model to a capture threshold;
dynamically adjusting the capture threshold based on device stability; and
determining the quality score exceeds the dynamically adjusted capture threshold.

19. A system comprising:
a camera;
a memory component; and
a processing device coupled to the memory component and the camera, the processing device to perform operations comprising:
receiving a first frame of a video stream from the camera, wherein the video stream comprises a plurality of frames depicting one or more document pages;
predicting, using a first machine learning model, a first score associated with the first frame;
determining the first score exceeds a first threshold;
providing the first frame to a second machine learning model;
predicting, using the second machine learning model, a second score associated with the first frame;
determining the second score exceeds a second threshold; and
capturing an image of a document page depicted in the first frame.

20. The system of claim 19, wherein the processing device performs further operations comprising:
receiving a second frame while the second machine learning model is processing the first frame; and
adding the second frame to a smart queue, wherein the smart queue selective stores a plurality of frames from the video stream such that a distance between stored frames is minimized.
